(19) United States
(12) Patent Application Publication
(10) Pub. No.: US 2025/0374167 A1
(43) Pub. Date: Dec. 4, 2025

(54) A CROSS-BORDER COMMUNICATION METHOD FOR WIRELESS MESH NETWORKS

(71) Applicant: SIGNIFY HOLDING B.V., EINDHOVEN (NL)

(72) Inventors: GOVIND NARAYAN, EINDHOVEN (NL); FELIX VARGHESE, THIRUVANANTHAPURAM (IN); ROBIN MICHIELSEN, EINDHOVEN (NL); GERHARDUS ENGBERTUS MEKENKAMP, VALKENSWAARD (NL)

(21) Appl. No.: 18/876,716

(22) PCT Filed: Jun. 20, 2023
(86) PCT No.: PCT/EP2023/066706

§ 371 Date: Dec. 19, 2024

(30) Foreign Application Priority Data
Jun. 27, 2022 (EP) 22181145.8

(51) Int. Cl. H04W 40/24; H04L 45/02; H04L 45/74

(52) U.S. Cl. CPC H04W 40/248; H04L 45/02; H04L 45/74

(57) ABSTRACT

A border node (200) located in an overlapping area of a first wireless mesh network (110) and a second wireless mesh network (120) with the second wireless mesh network (120) having a different network configuration as compared to the first wireless mesh network (110), the border node (200) comprising a radio configured to receive a first packet from the first wireless mesh network (110) operating on a first frequency channel; detect a data message from the first packet; compile the detected data message into a second packet with the second packet having a network header comprising a same network source address and a same network sequence number as comprised in a network header of the first packet; and send the second packet to the second wireless mesh network (120) operating on a second frequency channel, with the second frequency channel same or different from the first frequency channel.

### FIELD OF THE INVENTION

The invention relates to the field of cross-border wireless communication. More particularly, various methods, apparatus, and systems are disclosed herein related to filtering duplicated cross-network messages in an efficient manner.

### BACKGROUND OF THE INVENTION

Zigbee, Thread and Bluetooth Mesh are examples of wireless protocols that are targeted at IoT applications such as lighting and building automation. They provide a low latency, low-rate service that enables messages to be passed between, for example, a light switch and one or more luminaires. To enable messages to be routed correctly, each node on the wireless network is assigned a local network unicast address and may be addressed either directly as an individual node or, via a group address, as a member of a group. Once configured, such networks are typically expected to operate autonomously.

A control system deployed in a building may comprise of multiple Zigbee, Thread, or Bluetooth Mesh networks with each network comprising a plurality of electronic devices in a same room or on a same floor. Each network may be controlled in a standalone manner by deploying an individual switch/sensor/gateway with each of these networks. These standalone networks may not communicate with each other and may also reside on different frequency channels to reduce congestion and potential collision of messages.

However, there can be use cases where one would like to have communication between these standalone networks, such that a same control command may be applied to a large group of devices across different rooms/floors. In such a scenario, a cross-border communication is required.

In a Zigbee system, cross-border communication may be achieved by using Zigbee InterPAN messages. However, the limitation with InterPAN mechanism is that all the networks participating in such a communication must be on the same channel. Therefore, this solution lacks flexibility in certain application scenarios.

Some silicon vendors offer a multi-network feature that allows a single device to be on two different Zigbee networks. For example, a solution from Silicon Labs with its multi-network feature allows a device to be Zigbee router on one network and sleepy end device on the other. The networks can be on different channels and the device with multi-network feature does time sharing between these two networks. This solution can be used for cross border communication between the standalone networks. A device that is part of two different networks is called a border node and there may be multiple border nodes between two different networks.

US2014176340A1 relates to a transparent networking system for meter infrastructure, which comprises a first ZigBee network provided within a first spatial region and a second ZigBee network provided within a second spatial region. The network has a powerline carrier configured between the first ZigBee network and the second ZigBee network to facility transfer of bi-directional information packet by packet between the first ZigBee network and the second ZigBee networks.

EP3050314A1 relates to a system for connecting smart devices comprising at least two bridging devices, each arranged in relative proximity of at least one of at least two smart devices arranged at different locations within the building, wherein the at least two bridging devices are connected to the smart devices via a wireless connection and to each other via a broadband network.

### SUMMARY OF THE INVENTION

Multiple links may be created between adjacent networks via more than one border node. This is helpful in avoiding a single point of failure for communication between the networks. However, this also means that the same message may reach from one network to another multiple times via different paths. If a duplicate filtering mechanism is not implemented, undesired behavior may be observed, since all the incoming messages will be processed in the further network. For example, when a central switch sends a toggle light command, the lights can end up in different states across networks if the same message is received multiple times in a network.

It is recognized by the inventor that it is beneficial to implement duplicate filtering of messages via one or more border nodes in such a multi-network system. More particularly, the goal of this invention is achieved by a border node as claimed in claim 1, by a wireless communication system as claimed in claim 12, and by a method of a border node as claimed in claim 15.

In accordance with a first aspect of the invention a border node is provided. A border node located in an overlapping area of a first wireless mesh network and a second wireless mesh network with the second wireless mesh network having a different network configuration as compared to the first wireless mesh network, the border node comprises: a radio configured to receive a first packet from the first wireless mesh network operating on a first frequency channel; detect a data message from the first packet; compile the detected data message into a second packet with the second packet having a network header comprising a same network source address and a same network sequence number as comprised in a network header of the first packet; and send the second packet to the second wireless mesh network operating on a second frequency channel, with the second frequency channel same or different from the first frequency channel.

The border node is part of both the first wireless mesh network and the second wireless mesh network and identified in the two networks with different network addresses. To reduce congestion and mutual interference, it may be beneficial to operate adjacent mesh networks on different frequency channels, such that the first frequency channel may be different from the second frequency channel.

The radio may be a single chip radio device. More preferably, the radio is enabled by the multi-network feature as aforementioned.

For communications within a same network, duplicate filtering of broadcasted messages at network layer may be implemented by considering messages that have same source address and same network sequence number as duplicates. This way the duplicate messages will not reach the application layer as the protocol stack will drop the duplicate packets at network layer itself.

A border node can be used to forward data packets from the first network to the second or a further network. Communication across multiple Zigbee networks may be achieved by having at least one border node shared by any two adjacent networks. To deploy more than one border node in an overlapping area of two adjacent networks may help in avoiding a single point of failure for communication between the networks. However, this also means that a same message may reach from one network to another network multiple times via different paths. If a duplicate filtering mechanism is not implemented, undesired behavior may be seen, since typically all the incoming messages will be processed in the network. For example, when the message is related to a toggle light command, different lights may end up in different states across networks if the same message is received multiple times in a further network.

Therefore, a mechanism is required to enable duplicate filtering for inter-network communication. It is disclosed in the present invention that the network source address and network sequence number remain the same as in the original message from the first network thus avoiding processing of duplicate messages coming from multiple border nodes. By keeping the same network source address and same network sequence number, all the other nodes in the one or more further networks may easily identify if a newly received packet comprising a duplicated data message, such as being received earlier on, or not.

In a preferred embodiment, the border node is configured to have a first link group subscription, and a link endpoint subscription corresponding to the first link group subscription. The first link group subscription is shared by one or more nodes out of the first wireless mesh network and the second wireless mesh network; and the first packet is destined to the nodes belonging to the first link group.

Note that an endpoint is a logical extension defined by the application that can be thought of as devices accessible through a single radio. For example, a light switch attached to a radio might be one endpoint. A dimmer attached to the same radio might be another endpoint rather than a completely new application.

The nodes in the first wireless mesh network and the second wireless mesh network may have subscriptions to different link groups related to different applications and/or functions in the system. A single node may have subscriptions to more than one link groups. The same applies to the border node, which may also have subscriptions to more than one link group. Additionally, a border node will have a link endpoint subscription to facilitate cross-network communication.

Advantageously, the border node has subscriptions to a plurality of link groups, and a subscription to one or more link groups out of the plurality of link groups is shared by one or more nodes out of the first wireless mesh network and the second wireless mesh network, and a further first packet received by the border node from the first wireless mesh network is destined to nodes belonging to at least one out of the plurality of link groups.

In one option, the plurality of link groups may share a same link endpoint subscription, such that when a border node has a link endpoint subscription corresponding to the plurality of link groups, it will forward a data message destined to any link group out of the plurality of link groups to the second wireless mesh network.

In another option, a subset of the plurality of link groups may share a same link endpoint subscription. And then, the border node may receive a data message destined to any link group out of the plurality of link groups but will only forward a data message destined to a link group out of the subset of link groups to the second wireless mesh network, when it has a link endpoint subscription corresponding to that subset of link groups.

Thus, the link endpoint subscription may be corresponding to a single link group subscription, multiple link group subscriptions, or a subset out of a plurality of link group subscriptions that the border node has.

In one example, the first wireless mesh network and the second wireless mesh network are according to a Zigbee standard.

Zigbee standard is widely adopted in home automation and lighting control applications. The Zigbee network layer natively supports both star and tree networks, and generic mesh networking. The powerful topology control provides it great flexibility in a control system, especially for reaching destination nodes that are far away from a source node with direct link.

Preferably, the border node configured to act as a router node in the first wireless mesh network and as an end device or a router in the second wireless mesh network.

Zigbee specifies three different device types: the Zigbee Coordinator (ZC), the Zigbee Router (ZR), and the Zigbee End Device (ZED). These three devices play different roles in a Zigbee network. A Zigbee Router (ZR) passes data between devices and/or the coordinator. A Zigbee End Device (ZED) provides only basic functionality. ZEDs are leaf nodes. They communicate only through their parent nodes and, unlike router devices, cannot relay messages intended for other nodes. They don't participate in any routing. End devices rely on their parent routers to send and receive messages. Regarding IEEE 802.15.4, ZC and ZR are fully functional devices (FFDs), whereas the ZEDs are reduced function devices (RFDs).

The border node may operate as an end device or a sleepy end node in the second wireless mesh network. Normal end devices without tight power consumption requirements may choose to always have their radio on. A Sleepy End Device is a special kind of end device, which turns off its radio when idle, which makes it a suitable choice for battery operated devices.

In a preferred embodiment, the data message is a control command to control one or more nodes in the first and/or the second wireless mesh network.

The control command may be used for building automation to control sensors and actuators integrated in or co-located with the one or more nodes in the first and/or the second wireless mesh network.

Beneficially, the control command is for lighting control, such as to switch on/off a lamp or to change colour temperature of the lamp, etc. Different use cases may be enabled, such as
For large area light control
   Building/Floor with a centralized switch
   Circadian rhythm lighting using a single clock source
   Light control for Horticulture
   Automatic demand response
   Emergency test trigger and result readout
   Energy reporting from the drivers
For local area lighting control
   Control subset of rooms in a large space
   Corridor linking with motion detection in nearby rooms

As one detailed example, it may be desirable to have a central switch that lets the user turn off all the lights in the building. Without such a switch, the user will have to individually go to every room/floor and use the dedicated switch for the lights in that room.

In a further example, it may be required to read out energy consumption for all the networks in the area by connecting to just one of the networks, or to check status of emergency drivers in the building by connecting to just one network instead of individually connecting to the networks in which the emergency driver resides.

In another example, it may be desirable to send real time information to all the luminaires for synchronization of scheduling behaviour.

In all these scenarios, it is beneficial to allow a same control command to propagate across multiple networks to achieve a unified control effect.

Advantageously, the source address is a network address of a first node that initiates the control command.

The first node is located in the first wireless mesh network.

For a wireless mesh network, the network address may also be called a local identifier, a short address, or a node address. As one example, a Zigbee network adopts a 16-bit short address to uniquely identify a particular node within the network. For another type of short-range wireless communication network, the length of the network address may be different.

Lighting systems are becoming more and more wirelessly connected for both professional and home use cases. Devices in these wireless connected systems communicate using either standardized or proprietary protocols. Zigbee is a popular wireless mesh network protocol that is used extensively in many products.

In one example, the first node is a proxy node, a gateway or a central switch.

The control command may be initiated by a central controller of the system, which comprises more than one wireless mesh network. The central controller may be either a proxy node, a gateway, or a central switch. For example, in a gateway-less system it may also be the case that a proxy node receives a control message according to another communication protocol and injects the control message in the wireless mesh network. In one example, the proxy node may receive the control message via a BLE link and then inject the message in a Zigbee network.

In another example, the first node is a green power device.

The Zigbee Green Power protocol is an end-to-end open standard that allows ultra-low power devices called Green Power Devices (GPDs) to operate on Zigbee networks. It allows these devices to send messages reliably to destinations in the mesh network that may be well beyond the direct communication range of these ultra-low power devices. Such ultra-low power devices are typically based on energy-harvesting technology. Without requiring power supply or battery replacement, A Zigbee Green Power device can be put almost anywhere, especially in places that are hard to wire. Therefore, Green Power technology greatly improves the flexibility of IoT connectivity.

Beneficially, the first packet is a Zigbee Cluster Library Green Power, ZCL GP, command, or a ZCL GP notification.

The Zigbee Cluster Library (ZCL) is defined according to functional domains, such as General, Closures, HVAC, and Lighting. Clusters from these functional domains are used in the Zigbee Public Profiles to produce descriptions of devices, such as a dimming light, a dimmer switch, or a thermostat.

Advantageously, the second packet is a Zigbee Cluster Library, ZCL, command translated from a Zigbee Cluster Library Green Power, ZCL GP, notification.

Instead of transmitting the ZCL GP notification directly to the second mesh network, the border node may send the translated ZCL command to the second network. The advantage of this approach is that a conventional Zigbee node will be able to receive the ZCL command, and no green power commissioning is required for the second network.

In accordance with a second aspect of the invention a wireless communication system is provided. A wireless communication system comprising: a first wireless mesh network comprising a first plurality of nodes, a second wireless mesh network comprising a second plurality of nodes with the second wireless mesh network having a different network configuration as compared to the first wireless mesh network, and a border node, according to the present invention, located in an overlapping area of the first wireless mesh network and the second wireless mesh network.

The wireless communication system may comprise more than two mesh networks. For example, there may be a further mesh network located next to the second mesh network, and one or more border nodes located in the overlapping area of the second and the further mesh network are configured to forward data messages received in the second network to the further network. When the data messages are originated from the first mesh network, the network source address and network sequence number of the packets comprising the data messages remain the same when propagated from the first mesh network to the second mesh network and from the second mesh network to the further mesh network.

Beneficially, wherein the border node is configured to have a first link group subscription, and a link endpoint subscription corresponding to the first link group subscription. The first link group subscription is shared by one or more nodes out of the first wireless mesh network and the second wireless mesh network; and the first packet is destined to the nodes belonging to the first link group.

In another setup, the border node has subscriptions to a plurality of link groups, and a subscription to one or more link groups out of the plurality of link groups is shared by one or more nodes out of the first wireless mesh network and the second wireless mesh network, and a further first packet received by the border node from the first wireless mesh network is destined to nodes belonging to at least one out of the plurality of link groups.

In accordance with a third aspect of the invention a method is provided. A method of a border node according to the present invention, the method comprising the steps of: receiving a first packet from the first wireless mesh network operating on a first frequency channel; detecting a data message from the first packet; compiling the detected data message into a second packet with the second packet having a network header comprising a same network source address and a same network sequence number as comprised in a network header of the first packet; and sending the second packet to the second wireless mesh network operating on a second frequency channel, with the second frequency channel same or different from the first frequency channel.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 illustrates a wireless communication system comprising a plurality of mesh networks connected via border nodes;

FIG. 2 illustrates one example of a multi-network communication;

FIG. 3 illustrates a further example of a multi-network communication;

FIG. 4 illustrates a further example of a multi-network communication;

FIG. 5 illustrates one example of a small cluster inside a large multi-network area; and

FIG. 6. shows a flow diagram of a method of a border node.

### DETAILED DESCRIPTION OF EMBODIMENTS

The embodiments set forth below represent information to enable those skilled in the art to practice the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

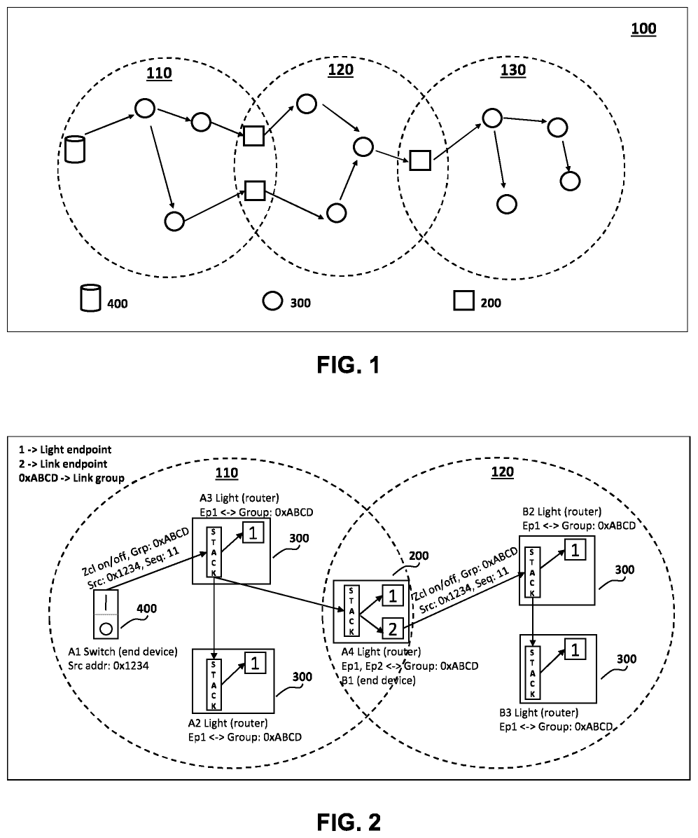

FIG. 1 illustrates a wireless communication system 100 comprising a plurality of mesh networks 110, 120, 130 connected via border nodes 200. Each mesh network 110, 120, 130 comprises a plurality of nodes or devices 200, 300. Different mesh networks 110, 120, 130 may operate on different frequency channels to reduce the chance of congestion or mutual interference among adjacent networks.

There may be a proxy node, a central switch, gateway, or a controller 400 configured to send out a data message or a control signal for nodes 200, 300 across more than one mesh network 110, 120, 130. A border node is a node located in an overlapping area between two adjacent networks, which constitutes a part in both networks and may be identified in the two networks via different network addresses. The border nodes located in the overlapping area of mesh networks 110 and 120 are configured to forward data messages originated from a first node, such as a gateway, a switch node, or a proxy device 400 in the first network 110 to the second network 120. Another border node located in the overlapping area of mesh networks 120 and 130 is configured to forward data messages originated from the first network 110 from the second network 120 to the further network 130.

Different embodiments of the present invention are further detailed in the context of a central switch 400 communicating across multiple wireless mesh networks 110, 120, 130. As an example, the central switch 400 may be a regular Zigbee switch, a Zigbee green power switch, or a proxy device. Similar approach can be applied to different use cases such as energy reading or configuring luminaires across networks. Communication across multiple Zigbee networks may be achieved by having at least one border node shared by any two adjacent networks. A special Zigbee group and endpoint for cross border communication are defined, which are called link group and link endpoint respectively.

The plurality of nodes 200 may have subscriptions to different link groups related to different applications and/or functions in the system. A single node may have subscriptions to more than one link groups. The same applies to the border nodes 200, which may also have subscriptions to more than one link group. Additionally, a border node 200 will have a link endpoint subscription to facilitate cross-network communication. The endpoint subscription may be corresponding to a single link group subscription, multiple link group subscriptions, or a subset out of a plurality of link group subscriptions that the border node 200 has.

As one example, a border node may subscribe to a plurality of link groups, and the plurality of link groups shares a same link endpoint subscription. When the border node receives a data message destined to any link group out of the plurality of link groups, it will forward the data message to a further wireless mesh network 120, 130.

In another example, for the plurality of link groups that the border node 200 has subscriptions, a subset of the plurality of link groups may share a same link endpoint subscription. And then, the border node 200 may receive a data message destined to any link group out of the plurality of link groups but will only forward a data message destined to a link group out of the subset of link groups to a further wireless mesh network 120, 130, when it has a link endpoint subscription corresponding to that subset of link groups.

With regard to a lighting control system, every node across networks may have a link group and light endpoint subscription for normal light control operation. On border nodes, in addition to the light endpoint, a link group and link endpoint subscription is added. In the following example, more details of how these link group and link endpoint are used for cross-border communication are disclosed.

FIG. 2 illustrates one example of a multi-network communication. In this example, the A1 switch 400 that initiates a control message is a regular Zigbee switch. For the plurality of nodes 300 and border nodes 200 in the system, light endpoint subscription is represented by 1, and link end point subscription is represented by 2, as recorded in the protocol stacks of the nodes 300, 200. A link group subscription is represented by 0xABCD in the figure. The transmission of a data message is represented by lines with arrows and the arrows are used to indicate the direction of transmission. The data message may be embedded in different data packets according to the configurations of a certain network. Depending on the operation frequencies of different networks, the border node may be also configured to switch from a first frequency channel of a first mesh network to a second frequency channel of a second mesh network for forwarding the data message.

As illustrated in the FIG. 2, when a data message or a Zigbee message is sent to the link group from the switch A1 400, all endpoints 200, 300 registered with that group get notified. This means that in case of border nodes A4 200, the message is received on link endpoint as well. When the border node 200 receives a message on link endpoint, it switches to the further network B1 120 and broadcasts the message as it is on the further network. The network source address and sequence number remain the same as in the original message from the first network 110 thus avoiding processing of duplicate messages coming from multiple border nodes. In another word, to avoid duplicated messages being forwarded by different border nodes located in the overlapping area of two adjacent networks, a border node is configured to keep the second packet to be transmitted to the further mesh network having a network header comprising a same network source address, e.g., src 0x1234, and a same network sequence number, e.g., seq: 11, as comprised in a network header of the first packet received from the first mesh network. By keeping the same network source address and same network sequence number, all the other nodes in the one or more further networks may easily identify if a newly received packet comprising a duplicated data message, such as being received earlier on, or not.

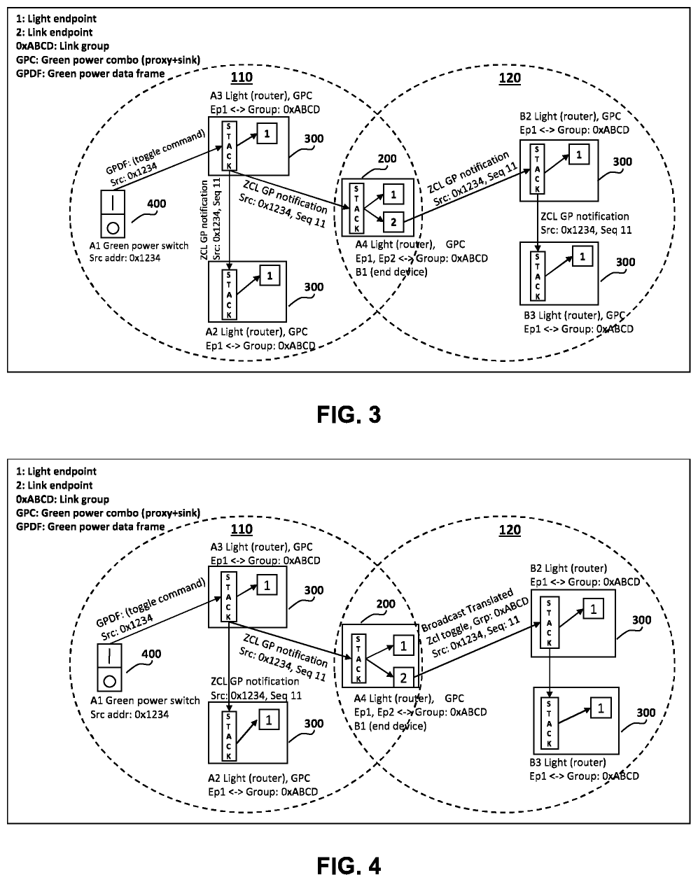

FIG. 3 illustrates an example of a multi-network communication in a system comprising green power devices. The main concept of cross-border communication remains the same in case of the central switch being a green power device. As shown in FIG. 3, the green power switch first sends out a green power data frame (GPDF) which is picked up by nearby green power proxies (GPP). The GPP's encapsulate the GPDF in a ZCL message and send it as a ZCL GP notification (multicast to group 0xABCD) to all the green power sinks (GPS). The GPS's then make use of their translation table entries to convert the incoming ZCL GP notification into ZCL toggle or on/off commands and pass it on to the registered endpoints on the node.

Since a border node has an extra registration of the link endpoint, when the message is received on the link endpoint, the border node simply switches to the further mesh network 120 and multicasts the same ZCL GP notification with same network source address and sequence number to the second network 120. This way the border node acts as a GPP for all other nodes on the second network 120. All GPS on second network 120 will process the incoming ZCL GP notification as they would normally do for messages originating from “real” proxies.

FIG. 4 illustrates a further example of a multi-network communication in a system comprising green power devices. In another variation of the green power switch 400 case, instead of injecting the ZCL GP notification, the border node 200 may inject the translated ZCL command into the second network 120. Again, the network source address used here would be of the green power switch 400 from which the command was initiated instead of the border node 200. The advantage of this approach is that no green power commissioning is needed on all further networks 120. FIG. 4 shows flow of messages with this approach.

In a potential application scenario, the system may comprise a plurality of small clusters/mesh networks inside a large multi-network area. As an example, there may be a centralized switch 400 controlling all the lights on a floor, and in parallel there may be some smaller sections in the system having an additional control mechanism, such as a few rooms with motion sensor linked with the corridor. This may be enabled by maintaining a whitelist of link groups on the border node 200, such that cross-border communication is only related to a subset of the plurality of link groups by having a link endpoint registration corresponding to the subset of link groups. And then, the border node 200 may receive a data message destined to any link group out of the plurality of link groups but will only forward a data message destined to a link group out of the subset of link groups to a further wireless mesh network 120, 130, when it has a link endpoint subscription corresponding to that subset of link groups.

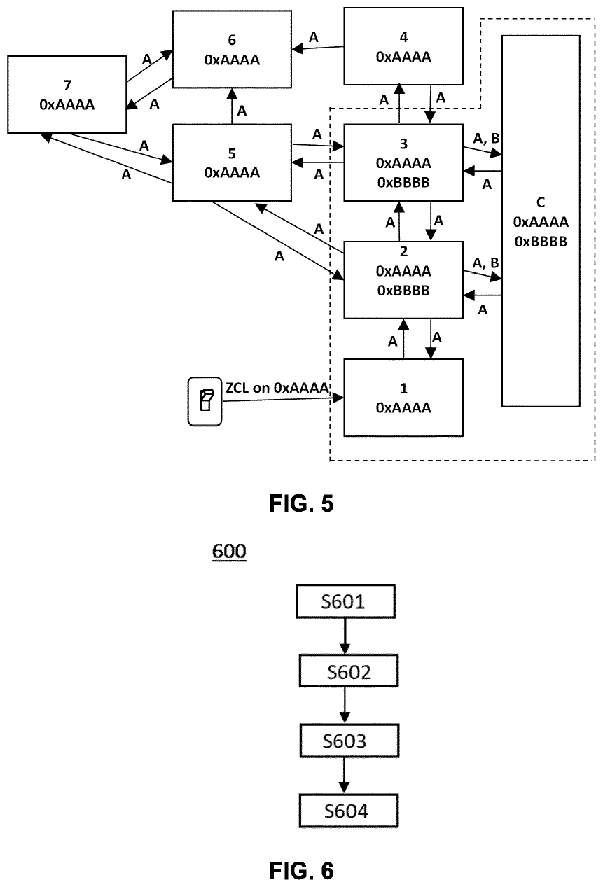

FIG. 5 shows such an example with the area inside the dash lines representing a small cluster inside a large multi-network area. This may be a centralized switch ZCL controlling all the lights on a floor and a smaller section where a few rooms with motion sensor are linked with the corridor. This is enabled by maintaining a whitelist of link groups on the border node as shown in the figure. Arrows indicate the links and direction of message flow from border nodes. Group 0xAAAA (abbreviated A) is used for the global multi-network communication and 0xBBBB (abbreviated B) is used for corridor linking use case.

Therefore, maintaining a whitelist of groups instead of using a single group may help in
Control lights in a smaller section of the building.
Restrict the control messages inside this smaller section
Use existing multi-network links for communication across networks

FIG. 6 shows a flow diagram of a method 600 of a border node 200. The method 600 comprising the steps of a border node 200: receiving in step S601 a first packet from the first wireless mesh network 110 operating on a first frequency channel; detecting in step S602 a data message from the first packet; compiling in step S603 the detected data message into a second packet with the second packet having a network header comprising a same network source address and a same network sequence number as comprised in a network header of the first packet; and sending in step S604 the second packet to the second wireless mesh network 120 operating on a second frequency channel, with the second frequency channel same or different from the first frequency channel.

The method according to the present invention may be implemented on a computer as a computer implemented method, or in dedicated hardware, or in a combination of both.

1. A border node located in an overlapping area of a first wireless mesh network and a second wireless mesh network with the second wireless mesh network having a different network configuration as compared to the first wireless mesh network, the border node comprising:
a radio configured to:
receive a first packet from the first wireless mesh network operating on a first frequency channel;
detect a data message from the first packet;
compile the detected data message into a second packet with the second packet having a network header comprising a same network source address and a same network sequence number as comprised in a network header of the first packet; and
send the second packet to the second wireless mesh network operating on a second frequency channel, with the second frequency channel same or different from the first frequency channel;
wherein the border node is configured to act as a router node in the first wireless mesh network and as an end device or a router in the second wireless mesh networks; and the data message is a control command to control more than one nodes in the first and second wireless mesh networks.

2. The border node of claim 1, wherein the border node is configured to have:
a first link group subscription, and
a link endpoint subscription corresponding to the first link group subscription;
wherein the first link group subscription is shared by one or more nodes out of the first wireless mesh network and the second wireless mesh network; and the first packet is destined to the nodes belonging to the first link group.

3. The border node of claim 2, wherein the border node has subscriptions to a plurality of link groups, and a subscription to one or more link groups out of the plurality of link groups is shared by one or more nodes out of the first wireless mesh network and the second wireless mesh network, and a further first packet received by the border node from the first wireless mesh network is destined to nodes belonging to at least one out of the plurality of link groups.

4. The border node of claim 1, wherein the first wireless mesh network and the second wireless mesh network are according to a Zigbee standard.

5. (canceled)

6. (canceled)

7. The border node of claim 16, wherein the source address is a network address of a first node that initiates the control command.

8. The border node of claim 7, wherein the first node is a proxy node, a gateway or a central switch.

9. The border node of claim 7, wherein the first node is a green power device.

10. The border node of claim 9, wherein the first packet is a Zigbee Cluster Library Green Power, ZCL GP, command, or a ZCL GP notification.

11. The border node of claim 9, wherein the second packet is a Zigbee Cluster Library, ZCL, command translated from a Zigbee Cluster Library Green Power, ZCL GP, notification.

12. A wireless communication system comprising:
a first wireless mesh network comprising a first plurality of nodes,
a second wireless mesh network comprising a second plurality of nodes with the second wireless mesh network having a different network configuration as compared to the first wireless mesh network, and
a border node, as claimed in claim 1, located in an overlapping area of the first wireless mesh network and the second wireless mesh network.

13. The wireless communication system of claim 12, wherein the border node is configured to have:
a first link group subscription, and
a link endpoint subscription corresponding to the first link group subscription;
wherein the first link group subscription is shared by one or more nodes out of the first wireless mesh network and the second wireless mesh network; and the first packet is destined to the nodes belonging to the first link group.

14. The wireless communication system of claim 13, wherein the border node has subscriptions to a plurality of link groups, and a subscription to one or more link groups out of the plurality of link groups is shared by one or more nodes out of the first wireless mesh network and the second wireless mesh network, and a further first packet received by the border node from the first wireless mesh network is destined to nodes belonging to at least one out of the plurality of link groups.

15. A method of a border node located in an overlapping area of a first wireless mesh network and a second wireless mesh network with the second wireless mesh network having a different network configuration as compared to the first wireless mesh network, the method comprising the steps of a radio comprised in the border node :
receiving a first packet from the first wireless mesh network operating on a first frequency channel;
detecting a data message from the first packet;
compiling the detected data message into a second packet with the second packet having a network header comprising a same network source address and a same network sequence number as comprised in a network header of the first packet; and
sending the second packet to the second wireless mesh network operating on a second frequency channel, with the second frequency channel same or different from the first frequency channel;
wherein the border node is configured to act as a router node in the first wireless mesh network and as an end device or a router in the second wireless mesh network; and the data message is a control command to control more than one nodes in the first and the second wireless mesh network.
